(19) United States
(12) Patent Application Publication
(10) Pub. No.: US 2004/0217959 A1
(43) Pub. Date: Nov. 4, 2004

(54) Method of displaying a video image on a digital display device

(76) Inventors: Didier Doyen, La Bouexiere (FR); Sebastien Weitbruch, Monchweiler (DE)

Correspondence Address: Joseph S Tripoli, Thomson Licensing Inc, Patent Operations CN 5312, Princeton, NJ, 08543-0028, US

(21) Appl. No.: 10/482,601

(22) PCT Filed: Jun. 20, 2002
(86) PCT No.: PCT/EP02/06835

(30) Foreign Application Priority Data
Jun. 28, 2001 (FR) 0108838

(51) Int. Cl. G06T 11/20

(52) U.S. Cl. 345/441

(57) ABSTRACT

The present invention relates to a method of displaying a video image on a digital display device and particularly on a plasma display panel. According to the invention, the cells of the device change state at most once during the image display period and the subscans of this display period are of two types. The subscans of the first type address two adjacent rows of the panel simultaneously and the subscans of the second type address each row of cells of the panel individually. In certain cases, the grey level delivered to the cells is modified before display. For two neighbouring cells sharing the same subscans of the second type and displaying the grey levels A and B, one of the grey levels, A or B, is modified if the first subscan for which one of the cells changes state is a subscan of the first type.

The present invention relates to a method of displaying a video image on a digital display device and particularly on a plasma display panel. The invention applies more particularly to plasma display panels (hereafter called PDPs) of the separate address/sustain and erase type.

The technology of PDPs allows large flat display screens to be obtained. PDPs generally comprise two insulation tiles defining a gas-filled space between them, in which space elementary spaces bounded by barriers are defined. Each tile is provided with one or more arrays of electrodes. An elementary cell corresponds to an elementary space provided, on each side of the said elementary space, with at least one electrode. To activate an elementary cell, an electrical discharge is generated in the corresponding elementary space by applying a voltage between the electrodes of the cell. The electrical discharge then causes the emission of UV radiation in the elementary cell. Phosphors deposited on the walls of the cell convert the UV into visible light.

The operating period of an elementary cell of the PDP corresponds to the period of display of a video image. Each cell may be found either in an on state or in an off state. The cell is kept in one of these states by sending a succession of pulses, called sustain pulses, for the time during which it is desired to keep it in this state. The ignition or addressing of a cell is carried out by sending a higher electrical pulse, also known as an address pulse. The extinction, or erasure, of the cell is carried out by eliminating the charges inside the cell by means of a damped discharge. To obtain various grey levels, a phenomenon of temporal integration by the eye is used by modulating the duration of the successive on and off states of the cell by means of subscans, or subframes, over the duration of the display of a video image.

FIG. 1 shows the temporal distribution of the subscans for displaying a video image. The total display time T of the image is 16.6 or 20 ms depending on the country. Eight subscans SS1 to SS8 are provided for displaying an image with 256 possible grey levels. Each subscan is used to turn a cell on, or not, for an illumination time Tᵢ this being a multiple of an elementary time Tₒ. Hereafter, the integer p such that Tᵢ=pTₒ denotes the weight of the subscan in question. The total duration of a subscan comprises an erase time Tₒ, an address time Tₐ, and an illumination time Tᵢ specific to each subscan. The address time Tₐ may be divided into n elementary durations Tₐₑ each corresponding to the address time for one row. The illumination time for each subscan is shown cross-hatched in FIG. 1. Denoting by Tₘₐₓ the maximum duration of illumination corresponding to the sum of the illumination times Tᵢ for a maximum grey level, then T is given by the following equation: T=m(Tₑ+nTₐₑ)+Tₘₐₓ, m representing the number of subscans of the image display period. However, this distribution of the illumination over a period of duration T poses a few problems associated with temporal integration by the human eye, especially the problem of contouring.

The problem of contouring appears when two neighbouring regions of the image have very similar grey levels with uncorrelated illumination times. With a subscan distribution similar to that in FIG. 1, the worst case is obtained with a transition between the grey levels 127 and 128. This is because the grey level 127 corresponds to an illumination over the first seven subscans SS1 to SS7 and the grey level 128 to an illumination over the eighth subscan SS8. These two neighbouring regions of respective grey levels 127 and 128 are never illuminated at the same time. When the image is static and the observer's eye is not moving over the screen, the observer performs a separate temporal integration of the subscans of each pixel and therefore sees two regions having relatively similar grey levels, namely 127 and 128. On the other hand, when the two regions are moving over the screen (and/or the observer's eye is moving), the eye integrates subscans relating to several pixels of the PDP. This results in the appearance of a dark or light band at the transition between the grey level 127 and the grey level 128.

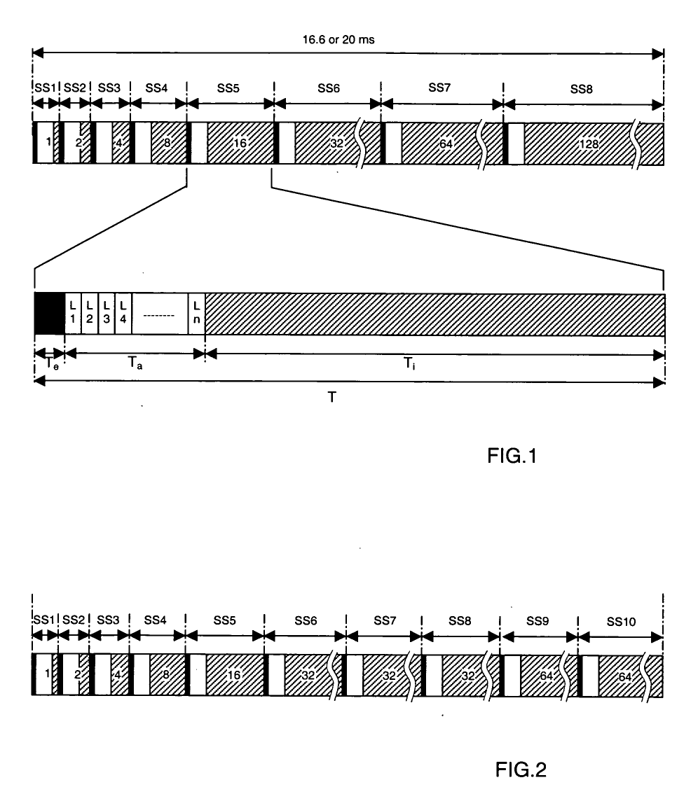

There are several known solutions for solving this contouring problem. The first solution consists in “breaking” the high-weight subscans in order to reduce the integration error, which means adding subscans. However, the total display time for an image, T=m(Tₑ+nTₐₑ)+Tₘₐₓ must remain fixed, which results in a reduction in the time Tₘₐₓ (since Tₒ and Tₐₑ are incompressible durations) and therefore a reduction in the maximum brightness of the PDP. It is then possible to use up to ten subscans while having correct brightness. FIG. 2 shows an example of addressing using ten subscans SS1 to SS10, in which the high-weight subscans are “broken” into two.

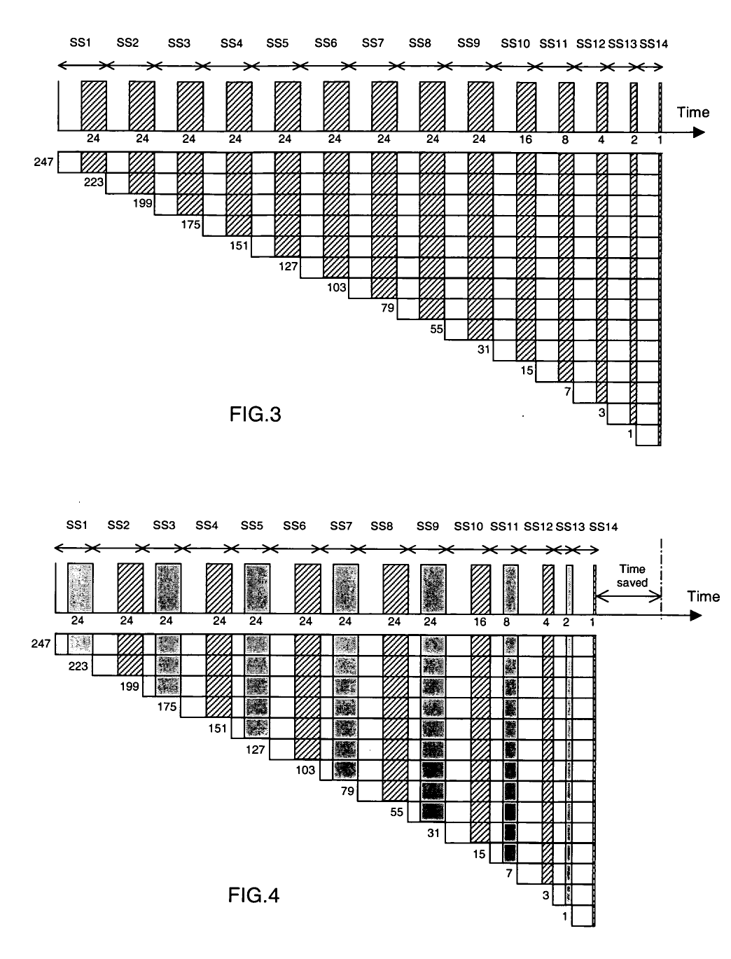

Another solution consists in using a restricted number of possible grey levels and in choosing them so that they do not create perturbations associated with temporal integration when displaying an image. In this solution, the grey levels are encoded according to a so-called incremental code. With this code, the cells of the PDP change state at least once during the image display period T. Thus, if a cell is in the off state at the start of the period T and switches to the on state during a given subscan of this period, it remains in this state until the end of the period. However, it should be noted that, although in the on state, the cell is in fact only ignited during the sustain periods (Tᵢ) of the subscan in question and of the subscans to follow of the period T. It should also be noted that the period T includes only one erase time Tₑ positioned at the end of the period T so that the cell remains in the on state until the end of the period. Therefore T=Tₑ+m(nTₐₑ)+Tₘₐₓ. The major drawback with this code is that the number of displayable grey levels is much reduced. It is equal to m+1 (it will be recalled that m is the number of subscans during the period T). FIG. 3 shows the displayable grey levels with an incremental code when the display period comprises fourteen subscans of weight 1, 2, 4, 8, 16, 24, 24, 24, 24, 24, 24, 24, 24, and 24. The fifteen displayable grey levels are then the levels 0, 1, 3, 7, 15, 31, 55, 79, 103, 127, 151, 175, 199, 223 and 247. In this figure, the subscans are arranged in the decreasing order of their weight (the case in which the cells are in the off state at the start of the period T). Techniques for error or noise diffusion, often called dithering, these being well known to those skilled in the art, make it possible to partly compensate for this small number of grey levels. The principle of the dithering technique consists in splitting the desired grey level into a combination of displayable grey levels which, by temporal integration (these grey levels are displayed over several successive images) or by spatial integration (these grey levels are displayed in a region of the image encompassing the pixel in question), reproduce on the screen a grey level close to the desired grey level. All the same, it is desirable to increase the number of displayable grey levels with an incremental code in order to further improve the result of the dithering operation.

It is an object of the invention therefore to increase the number of possible grey levels displayable with an incremental code without reducing the brightness of the plasma display panel. To do this, the sole solution consists in increasing the number of subscans of the image display period.

According to the invention, provision is therefore made to use the video redundancy existing between neighbouring pixels in the PDP to reduce the address time of the cells and thus increase the number of subscans of the image display period.

The invention is a method of displaying a video image on a digital display device during a display time, the said device comprising a plurality of cells arranged in rows and columns, the video image display time being composed of a plurality of periods called subscans during which each cell of the said device is either in the on state or in the off state. According to the invention, the cells of the said device change state at most once during the said video image display time, and the subscans are divided into subscans of a first type and subscans of a second type, the subscans of the first type addressing two adjacent rows of cells of the said device simultaneously and the subscans of the second type addressing each row of cells of the device individually.

According to preferred embodiments, each subscan of the first type is either immediately preceded, either immediately followed by a subscan of the second type. The subscans of the first type and of the second type alternate during the video image display time. The number of subscans of the first type is equal to the number of subscans of the second type. The subscans of the first type and of the second type alternate as two subscans of the first type for one subscan of the second type during the video image display time.

Moreover, if, for two neighbouring cells sharing the same subscans of the second type and used to display grey levels A and B respectively, the first subscan for which one of the said neighbouring cells changes state is a subscan of the first type, then one of the grey levels, A or B, is modified beforehand so that the grey levels A and B are equal or so that the first subscan for which one of the said neighbouring cells changes state is a subscan of the second type.

The invention also relates to a plasma display panel which includes a device intended to implement the display method defined above.

Further features and advantages of the invention will become apparent on reading the detailed description which follows and which is given with reference to the appended drawings, in which:

FIGS. 1 and 2 show the time divisions of subscans during the image display according to the prior art;

FIG. 3 shows the grey levels displayable with fourteen subscans according to an incremental code;

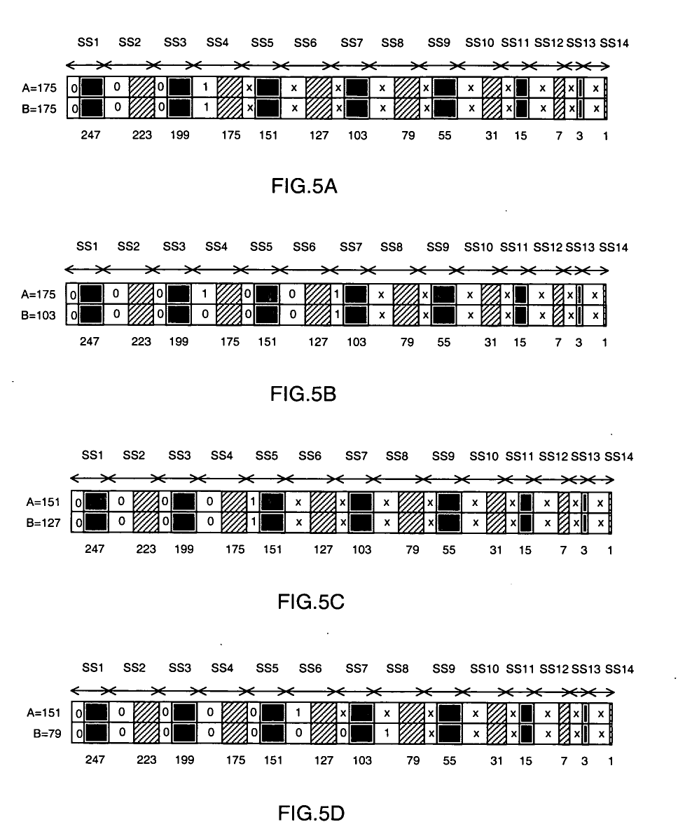

FIGS. 4 and 5A to 5D illustrate a first way of implementing the method of the invention;

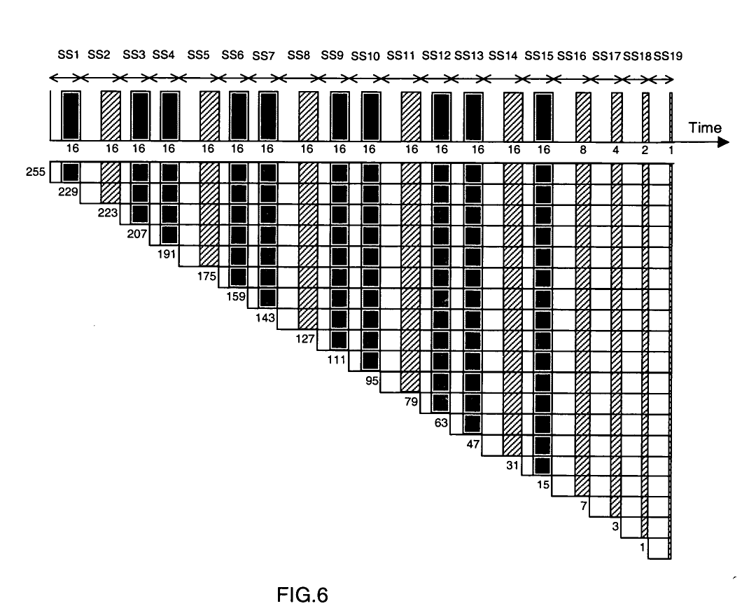

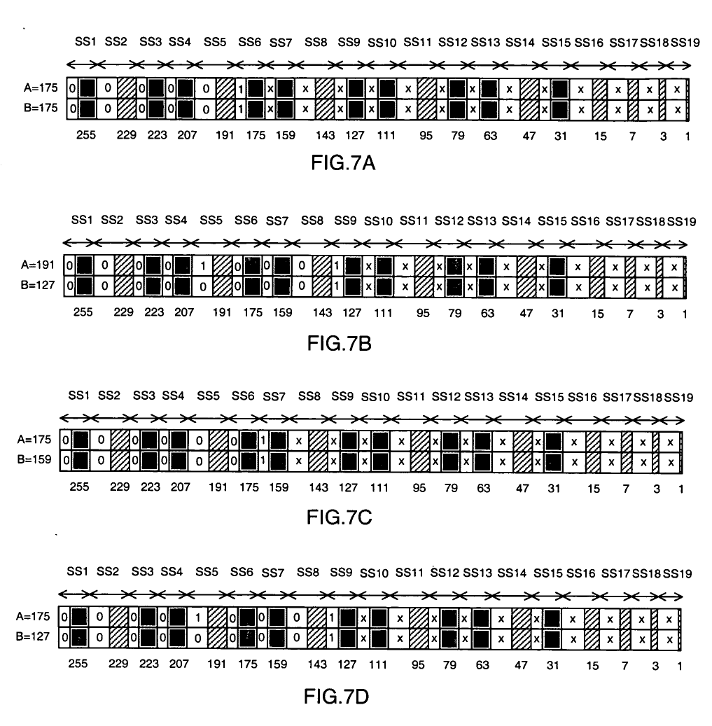

FIGS. 6 and 7A to 7D illustrate a second way of implementing the method of the invention; and

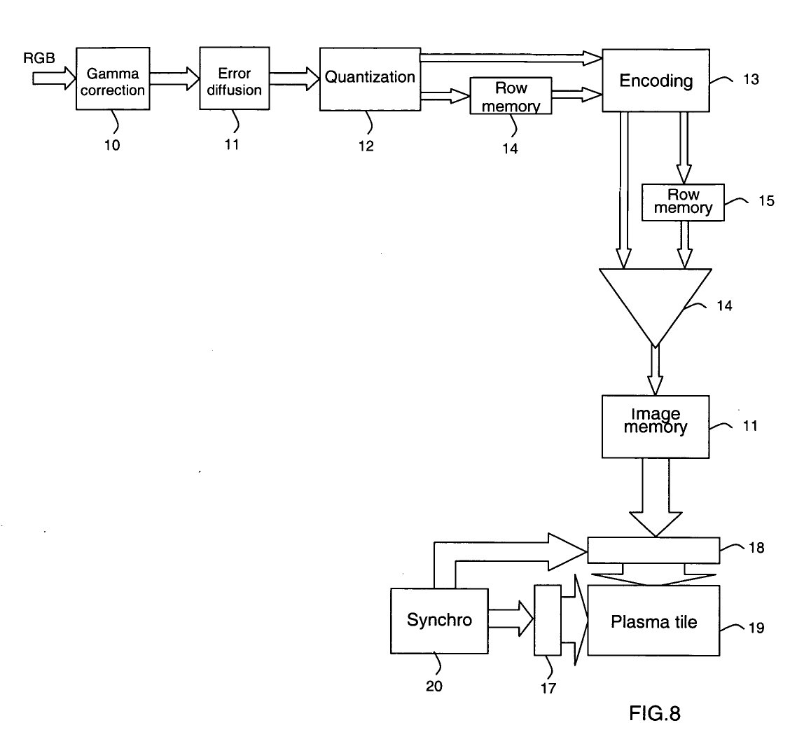

FIG. 8 is a block diagram of a PDP in which the method of the invention is employed.

The display method forming the subject matter of the present invention uses the video redundancy between neighbouring pixels (belonging to neighbouring rows of the PDP) to reduce the address time for each cell of the PDP.

According to the invention, provision is made for two successive rows of the PDP to be scanned simultaneously for certain subscans. This technique, known for a conventional plasma addressing, has never been applied within the context of a display with grey levels encoded according to an incremental code. The use of an incremental code imposes that the change of state of a cell happens only once but a simultaneous addressing of two lines does not permit to address simultaneously cells with distant levels.

According to the invention, the subscans of the period T are therefore divided into two groups: on the one hand, the subscans of a first type addressing two adjacent rows of the PDP simultaneously and, on the other hand, the subscans of a second type which address only a single row of cells at a time.

If for example an image display period comprising m subscans is considered, among which m₁ subscans are addressed simultaneously for two successive rows of the PDP, then the following equation may be written:

T=Tₑ+(m−m₁)(nTₐₑ)+m₁(½nTₐₑ)+Tₘₐₓ

This technique makes it possible to reduce the address time for the m₁ subscans of the first type by a factor of two and thus add additional subscans without reducing Tₘₐₓ.

A first way of implementing the method of the invention is illustrated in FIG. 4. The image display period comprises fourteen subscans, including seven of the first type and seven of the second type. The subscans of the first type and of the second type are arranged alternately, namely a subscan of the first type, a subscan of the second type, a subscan of the first type, etc. The illumination period of the first-type subscans is shaded grey and that of the second-type subscans is hatched. The total address time is equal to (7+7/2)Tₐ instead of 14Tₐ. The time saving in terms of addressing is therefore 25%. This saved time is used to increase the number of subscans of the display period. It would also be possible to envisage using it to increase the brightness of the PDP by increasing the duration of the illumination period of the subscans.

Through many cases that can appear, it will now be explained how it is possible to use common addressing of at least two cells according to the invention.

To illustrate these problems, let us consider two cells C1 and C2 of the PDP which share the same first-type subscans and display a grey level A and a grey level B, respectively. Let U denote the higher grey level between A and B and L the lower grey level. Moreover, it will be considered that the cells C1 and C2 are in the off state at the start of the display period.

Case 1

If A=B, the cells C1 and C2 switch into the on state during the same subscan; there is therefore no problem in displaying the grey levels A and B in the cells C1 and C2, respectively.

Case 2

If, in order to display the grey level U, the first subscan for which the corresponding cell (C1 or C2) is on is a second-type subscan, there is still no problem since this switch to the on state of the cell in question does not involve the switching of the other cell to the on state.

Case 3

Finally, if, to display the grey level U, the first subscan for which the corresponding cell is on is a first-type subscan, there will be a problem as both cells then switch to the on state. Two cases may therefore be distinguished:

(3.1) if the grey levels A and B are adjacent grey levels in the ordered list of displayable grey levels 0, 1, 3, 7, 15, 31, 55, 79, 103, 127, 151, 175, 199, 223 and 247, the solution is then one of modifying one of the two grey levels, A or B, so as to make A=B; to do this, it is possible either to replace U with the displayable grey level which is immediately below it or to replace L with the displayable grey level which is immediately above it; this finally makes U=L=A=B;

(3.2) if the grey levels A and B are not adjacent grey levels in the ordered list of displayable grey levels, it is necessary to modify the grey level U so that the first subscan for which the corresponding cell is on is a second-type subscan; to do this, it is possible either to replace U with the displayable grey level which is immediately below it or immediately above it.

Only case 3 introduces noise into the display of the image. However, given the many redundancies in video images, the case most often encountered is case 1 (50% of the time). For the remainder, cases 2 and 3 are equally probable (each 25% of the time). Finally, of cases 3.1 and 3.2, case 3.1 is encountered more often (20% of the time for case for 3.1 as opposed to 5% of the time for case 3.2). The treatment applied to case 3.1 is that which is the least visible since it evens out the image regions having similar grey levels. It may also be noted that a large percentage of cases 3.1 would be encountered in case 1 if no dithering operation were applied beforehand to the image.

These three cases are illustrated by application examples shown in FIGS. 5A to 5D. In these figures, addressing with a value 1 during a subscan means that the corresponding cell is turned on during this subscan. Addressing with a value 0 means that it is turned off.

FIG. 5A illustrates the case in which A=B=175. The cells C1 and C2 switch to the on state during the subscan SS4 and remain in this state until the end of the display period, whatever the values, 0 or 1, addressed during the remainder of the display period (x denotes either the value 0 or the value 1).

FIG. 5B illustrates the case in which A=175 and B=103. The cell C1 switches to the on state during the subscan SS4 and remains thus until the end of the display period. Given that the subscan SS4 is not of the first type, it is possible not to turn the cell C2 on during this subscan. The value 0 is therefore addressed to the cell C2 during the subscan SS4. To obtain the grey level 103, the value 1 is addressed to the cell C2 during the subscan SS7. Since the subscan SS7 is a first-type subscan, this value is also applied to the cell C1. During the remainder of the subscans—SS8 to SS14—the cells C1 and C2 remain in the on state.

FIG. 5C illustrates the case in which A=151 and B=127. To obtain the grey level 151, the value 1 is addressed during the first-type subscan SS5. This value is applied to both cells C1 and C2. However, since these two grey levels are adjacent in the list of displayable grey levels, it is possible to choose to display either a grey level 151 or a grey level 127 in both cells. In the example in FIG. 5C, a grey level 151 is displayed in both cells. The value 1 is therefore applied to the cells C1 and C2 during the subscan SS5.

Finally, FIG. 5D illustrates the case in which A=151 and B=79. For this case, it has been chosen to reduce the value of A to 127 in order firstly to turn on a second type subscan, namely the subscan SS6.

A second way of implementing the method of the invention is illustrated in FIG. 6. The display period comprises nineteen subscans SS1 to SS19, including ten of the first type and nine of the second type. The subscans SS1 to SS15 have a weight of 16 and the subscans SS16, SS17, SS18 and SS19 have a weight of 8, 4, 2 and 1, respectively. The subscans of the first type and of the second type alternate as two first-type subscans for one second-type subscan, or at least for subscans of weight 16. Thus, the subscans SS1, SS3, SS4, SS6, SS7, SS9, SS10, SS11, SS12 and SS13 are of the first type and the subscans SS2, SS5, SS8, SS11, SS14, SS16, SS17, SS18 and SS19 are of the second type. The displayable grey levels with this combination of subscans are the following: 0, 1, 3, 7, 15, 31, 47, 63, 79, 95, 111, 127, 143, 159, 175, 191, 207, 223, 239, 255. The total address time is equal to (9+½ 10)Tₐ instead of 19Tₐ. The time saving in terms of addressing is therefore 26%.

As in the case of the previous mode of implementation, the display may pose a few problems. To illustrate these problems, let us again consider the cells C1 and C2 sharing the same first-type subscans and displaying a grey level A and a grey level B respectively. U denotes the higher grey level between A and B and L the lower grey level. Cases 1, 2 and 3.1 are identical to those described previously.

For case 3.2 (the case in which the first subscan for which a cell changes state is a first-type subscan), it is necessary to modify the grey level U so that the first subscan for which one of the two cells changes state is a second-type subscan. To do this, U is then replaced with the displayable grey level immediately below or immediately above, depending on the subscan in question.

Application examples are given below in order to illustrate this mode of implementation.

FIG. 7A illustrates the case in which A=B=175. The cells C1 and C2 switch to the on state during the subscan SS6 and remain in this state until the end of the display period.

FIG. 7B illustrates the case in which A=191 and B=127. The cell C1 switches to the on state during the subscan SS5 and remains in this state until the end of the display period. Given that the subscan SS5 is not of the first type, it is possible not to turn the cell C2 on during this subscan. The value 0 is therefore addressed to the cell C2 during the subscan SS5. To obtain the grey level 127, the value 1 is addressed to the cell C2 during the subscan SS9. Since the subscan SS9 is a first-type subscan, this value is also addressed to the cell C1. During the remaining subscans SS10 to SS19, the cells C1 and C2 remain in the on state.

FIG. 7C illustrates the case in which A=175 and B=159. To obtain the grey level 175, the value 1 must normally be addressed during the first-type subscan SS6. This value is applied to both cells C1 and C2. However, since these two grey levels are adjacent in the list of displayable grey levels, it is possible to decide to display in both cells either the grey level 175 or the grey level 159. In the example of FIG. 7C, the grey level 159 is displayed in both cells. The value 1 is therefore addressed to the cells C1 and C2 during the subscan SS7.

FIG. 7D illustrates the case in which A=175 and B=127. For this case, it was chosen to increase the value of A to 191 in order to turn on firstly a second-type subscan, namely the subscan SS5.

In all the application examples given above, the cells are in the off state at the start of the display period and switched to the on state during the display period (except for the cells displaying a grey level 0). The principle of the invention is also applicable to cells which are in the on state at the start of the display period and which are subsequently turned off. This method introduces slight noise (case 3.2) in the display of an image. However, this noise is very low as it relates only to a small number of pixels and the maximum value of this noise is equal to the high-weight of the subscans, i.e. 16 in the example in FIG. 6. On the other hand, this method does allow the number of subscans during the image display period to be significantly increased. It is possible to increase the number of subscans even further by addressing more than two adjacent rows of cells simultaneously.

Very many structures are possible for implementing the method of the invention. A PDP implementing the method of the invention is shown in FIG. 8. A stream of R,G,B video signals is received by a gamma correction circuit 10. The purpose of this correction is to correct the linearity defects of the PDP. The corrected signals are then processed by an error diffusion circuit 11 and a quantization circuit 12 in order to encode the said signals with an incremental code. The purpose of the error diffusion is to shade off the effects of quantization on the image resolution. At the end of this quantization, the pixels are, for example, encoded over N bits (that is to say 2^{N} possible grey level values). Next, the signals are processed by an encoding circuit 13 intended to modify the grey level values if necessary (case 3.2). The encoding circuit 13 has two inputs for receiving the pixels row by row, the first input being for example intended to receive the odd rows of the image and the second input the even rows (the case of addressing the two adjacent rows simultaneously). In order for the adjacent rows of the image to be processed simultaneously in the encoding circuit 13, a row memory 14 is provided in order to delay the first row of pixels. The rows of pixels processed simultaneously are delivered to two separate outputs and are sent to an image memory 16 via an output multiplexer 14. A row memory 15 is also provided for delaying the second row of pixels at the output of the encoding circuit 13. The output multiplexer 14 switches alternately between the two outputs of the encoding circuit 13. Next, the image memory 16 delivers the video signals to a row driver 17 and a column driver 18 of a plasma tile 19. A synchronization circuit 20 is provided for synchronizing the drivers 17 and 18. This arrangement is given merely as an illustration.

As previously indicated, the incremental code can also be used with an addressing by erasing. The invention also applies as previously indicated but, instead of ordering the lighting of a cell, the extinction of said cell is ordered.

As well, the invention is described for a plasma display panel but it can be used for any other display device including a plurality of cells being in on or off state. Thus, the micro-mirrors devices and the digital LCOS display devices can use the present invention.

What is claimed is:

1. Method of displaying a video image on a display device during a display time, the said device comprising a plurality of cells arranged in rows and columns, the video image display time being composed of a plurality of periods called subscans during which each cell of the said device is either in the on state or in the off state, wherein the cells of the said device change state at most once during the said video image display time and in that the subscans are divided into subscans of a first type and subscans of a second type, the subscans of the first type addressing two adjacent rows of cells of the said device simultaneously and the subscans of the second type addressing each row of cells of the device individually.

2. Method according to claim 1, wherein each subscan of the first type is either immediately preceded, either immediately followed by a subscan of the second type.

3. Method according to claim 1, wherein the subscans of the first type and of the second type alternate during the video image display time.

4. Method according to claim 3, wherein the number of subscans of the first type is equal to the number of subscans of the second type.

5. Method according to claim 3, wherein the subscans of the first type and of the second type alternate as two subscans of the first type for one subscan of the second type during the video image display time.

6. Method according to claim 2, wherein, for two neighbouring cells sharing the same subscans of the second type and used to display grey levels A and B respectively, one of the grey levels, A or B, is modified beforehand if the first subscan for which one of the said neighbouring cells changes state is a subscan of the first type, so that the grey levels A and B are equal or so that the first subscan for which the said cell which changes state is a subscan of the second type.

7. Method according to claim 1, wherein all the cells of the said panel are in the off state at the start of the said video image display time.

8. Method according to claim 1, all the cells of the said panel are in the on state at the start of the said video image display time.

9. Plasma display panel, wherein it includes a device implementing the display method of claim 1.
